(19) United States
(12) Patent Application Publication
(10) Pub. No.: US 2006/0043860 A1
(43) Pub. Date: Mar. 2, 2006

(54) Display panel, light-emitting unit used for the display panel and image display device

(75) Inventor: Masanori Haba, Tokyo (JP)

Correspondence Address: MCDERMOTT WILL & EMERY LLP, 600 13TH STREET, N.W., WASHINGTON, DC, 20005-3096, US

(73) Assignee: DIALIGHT JAPAN CO., LTD.

(21) Appl. No.: 11/119,850

(22) Filed: May 3, 2005

(30) Foreign Application Priority Data
Aug. 26, 2004 (JP) P2004-247209

(51) Int. Cl. H01J 9/02

(52) U.S. Cl. 313/310

(57) ABSTRACT

A display panel according to the present invention has plural light-emitting units arranged every housing space for the respective display pixels. Each of the light-emitting units has a vacuum sealing tube, phosphor-coated anode section and linear cathode section, wherein the linear cathode section has a conductive wire, a great number of field concentration assisting concave/convex sections and a carbon-based film provided with a great number of sharp microscopic sections formed as a field electron emitter.

### BACKGROUND OF THE INVENTION

1. Field of the Invention

The present invention relates to a display panel having matrix-arranged display pixels, each of which is a unit for composing an image, a light emitting unit used for the display panel and an image display device.

2. Description of the Prior Arts

A liquid crystal display device wherein display pixels, each of which is a unit for composing an image, are composed of liquid crystal and the liquid crystal display pixels are matrix-arranged has, for example, a liquid crystal display panel and a backlight that lights the backside of the liquid crystal display panel. A liquid crystal display device described above has been used for a wide variety of electronic devices such as a liquid crystal television set, portable terminal, personal computer, electronic notebook and camera-integrated VTR, since it has a thin size, light weight and reduced power consumption (see Japanese Unexamined Patent Application No. 2003-84715).

However, in such a liquid crystal display device, the power consumption at the backlight occupies most of the power consumption of the liquid crystal display device, since the backside of the liquid crystal display panel is lighted. In the case where the liquid crystal display device described above is used as a large-sized liquid crystal television set that is installed outdoor, the power consumption runs up by the backlight. Further, a great number of expensive color filters required for a color display are necessary.

On the other hand, a display device wherein light-emitting diodes are matrix-arranged as display pixels has been used, for example, as a display device using only a display panel, not using liquid crystal and backlight, in a large-sized outdoor-installed liquid crystal television. However, it has many subjects that it is inferior to the liquid crystal in a display quality, power consumption due to the light-emitting diodes becomes extremely great even though the backlight is not used, the handling of this device is troublesome because of heat generation, or the like.

In view of the above-mentioned circumstances, the present inventor has made an earnest study in order to provide a display panel that is particularly useful for a large-sized outdoor-installed device without using liquid crystal and light-emitting diodes.

The present invention aims to provide a novel display panel without using conventional liquid crystal or light-emitting diodes, a light-emitting unit used for this display panel and an image display device.

### SUMMARY OF THE INVENTION

A display panel according to the present invention is provided with plural display pixels arranged therein and comprises housing spaces formed so as to individually correspond to the display pixels and plural light-emitting diodes juxtaposed to each other in each of the housing spaces, wherein each light-emitting diode has a vacuum sealing tube and a phosphor-coated anode section and linear cathode section, each of which is arranged so as to oppose to each other in the vacuum sealing tube, wherein the linear cathode section has a conductive wire arranged immediately below the phosphor-coated anode section so as to extend linearly, a great number of field concentration assisting concave/convex sections formed on the outer peripheral surface of the conductive wire and a carbon-based film formed as a field electron emitter and having a great number of sharp microscopic sections on the field concentration assisting concave/convex sections, and each display pixel emits light to be displayed by the plural light-emitting units arranged in each of the housing spaces.

Different from the display panel using the liquid crystal, the light-emitting unit composing each pixel operates as a field electron emission type fluorescent tube in the display panel of the present invention. Therefore, the present invention can provide a novel image display device having advantages that it has extremely less power consumption, it can emit light with high quality and high intensity, a backlight is unnecessary since the liquid crystal is not used, thereby being capable of accomplishing reduced power consumption, and the number of components is decreased since a color filter is unnecessary, thereby being capable of reducing production cost.

The display panel of the present invention does not use a light-emitting element such as a light-emitting diode. The light-emitting units composing each pixel has reduced power consumption, is excellent in display quality and does not generate heat, whereby more reduced power consumption can be obtained, which provides convenient handling. Further, it does not use a light-emitting diode whose unit price is expensive, whereby the invention can provide an image display device at a lower cost.

The feature worthy of mention is that, in the construction of the light-emitting unit, the linear cathode section has a conductive wire, a great number of field concentration assisting concave/convex sections formed on the outer peripheral surface of the conductive wire and a carbon-based film formed as a field electron emitter and having a great number of sharp microscopic sections on the field concentration assisting concave/convex sections. It is not the one wherein the carbon-based film is only formed on the outer peripheral surface of the conductive wire, but wherein the field concentration assisting concave/convex sections are formed and the carbon-based film is formed on the outer peripheral surface of the field concentration assisting concave/convex sections. Therefore, with the state where the field concentration is strongly caused by the field concentration assisting concave/convex sections, the field concentration is more strongly caused by a great number of microscopic needle-like or wall-like sharp sections of the carbon-based film, whereby a great number of electrons are drawn out. Consequently, a gate electrode for conventionally drawing out electrons from the carbon-based film is unnecessary, and therefore, the present invention enables a high-intensity light-emission with a low cost, reduced power consumption and a simple bipolar structure of an anode and a cathode. This brings a reduction or decrease in the unit price of each light-emitting unit. Accordingly, it is needless to say that the present invention is useful, enhances industrial applicability and greatly contributes to the development of industry in the display panel having a great number of display pixels arranged therein.

The above-mentioned “linear” is not limited to a straight line shape, but includes a curved line such as a spiral shape or wave-like shape, a shape wherein a curved line and straight line are mixed, and other shape. Further, it does not matter whether it has a solid-core or is hollow. Further, its sectional shape is not particularly limited. Specifically, its sectional shape is not limited to a circle, but may be an ellipse, rectangle or other shape. The above-mentioned “field concentration assigning concave/convex sections” include field concentration assisting concave/convex sections each having a visible size made of projections or grooves and also field concentration assisting concave/convex sections each having a microscopic size formed by surface roughness or the like. Its size does not matter. Further, the forming direction of the concave/convex sections may be a circumferential direction or longitudinal direction of the conductive wire, but the longitudinal direction is particularly effective. A technique for forming the concave/convex sections in the longitudinal direction of the conductive wire includes, for example, stretching the conductive wire. As microscopic concave/convex sections, ribbed concave/convex sections may be formed with nm-order or the like by grinding the outer peripheral surface of the conductive wire and selecting the surface roughness. The carbon-based film includes a film made of carbon-nano material having a tube shape, wall shape or other shape as the microscopic sharp sections. The shape having somewhat roundness can be included in the above-mentioned “sharp” shape so long as it has electron emission property.

The present invention can provide a novel display panel that can display an image with reduced power consumption, high intensity and low heat generation.

### BRIEF DESCRIPTION OF THE DRAWINGS

Fig. 1 is a block diagram showing a data line driving circuit, a scanning line driving circuit and a display panel according to an embodiment of the present invention;

FIG. 2 is a partially enlarged plane view showing the display panel of FIG. 1;

FIG. 3 is an enlarged plane view showing each display pixel of FIG. 2;

FIG. 4 is a perspective view showing a light-emitting unit arranged at the display pixel of FIG. 3;

FIG. 5 is a sectional view showing the light-emitting unit of FIG. 4; and

FIG. 6 is a sectional view corresponding to FIG. 4 and showing a light-emitting unit to which a high-voltage transformer is fixed.

### DETAILED DESCRIPTION OF PREFERRED EMBODIMENT

A display panel according to an embodiment of the present invention is explained in detail hereinafter with reference to the attached drawings.

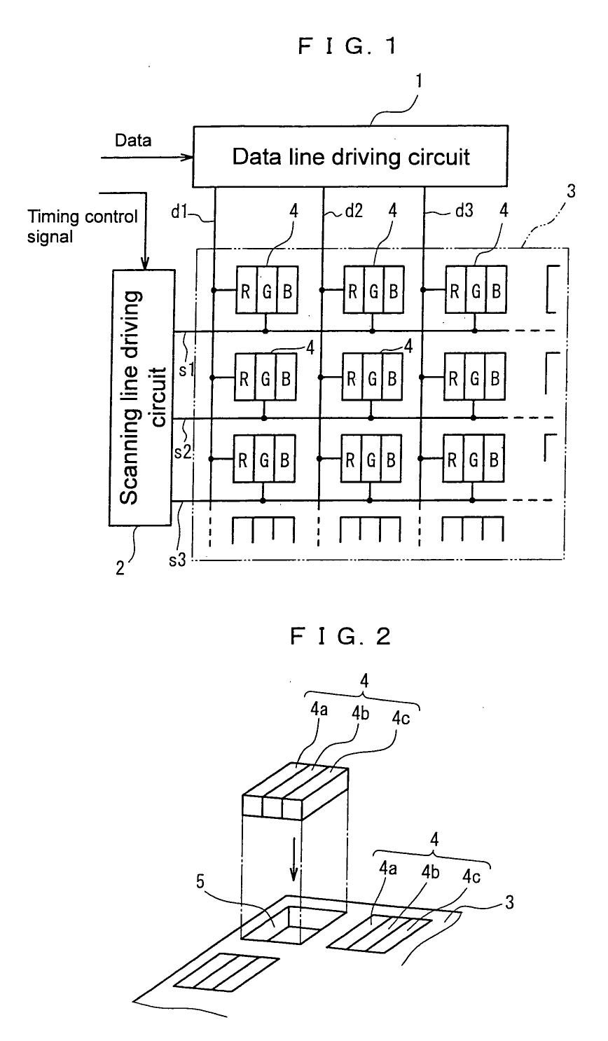

A display panel according to the embodiment of the present invention is explained with reference to FIG. 1. FIG. 1 is a block diagram showing a data line driving circuit, a scanning line driving circuit and the display panel according to the embodiment of the present invention. Numeral 1 denotes the data line driving circuit, 2 the scanning line driving circuit and 3 the display panel. The data line driving circuit 1, the scanning line driving circuit 2 and the display panel 3 compose an image display device. A liquid crystal television set is provided with many electronic circuits therein such as an electronic tuner other than the image display device, but the present specification omits the explanation thereof.

Information (data) of each color of RGB relating to an image is given to the data line driving circuit 1. The data line driving circuit 1 selectively drives data lines d1, d2, d3 . . . according to the given information. The scanning line driving circuit 2 successively outputs a scanning line signal to each scanning line s1, s2, s3, . . . in response to a timing control signal. It should be noted that the data line driving circuit 1 and the scanning line driving circuit 2 are described solely for the purpose of illustration, and do not limit the present invention.

The display panel 3 has display pixels 4 arranged in a matrix. Each display pixel 4 is selectively driven by the driving signal from the data line driving circuit 1 and the driving signal from the scanning line driving circuit 2 to thereby emit light of R (red) color, G (green) color and B (blue) color. It should be noted that the light-emitting operation at the display panel 3 by the driving signals is well known, so that its detailed explanation is omitted. Further, the number of the display pixels 4 is suitably determined according to the use and object. It is not limited to the illustration shown in the figure.

The construction of the display panel 4 will be explained with reference to FIG. 2. FIG. 2 is a partially enlarged perspective view showing the display pane 13. The display pixel 4 is composed of plural light-emitting units 4a, 4b and 4c. The display panel 3 has housing spaces 5 in a matrix that can accommodate the display pixel 4. Each housing space 5 has a concave shape wherein three light-emitting units 4a, 4b and 4c can be accommodated. The concave shape is a square or a rectangle seen from the plane direction. The shape of each of the light-emitting units 4a, 4b and 4c is a rectangle seen from the plane direction. FIG. 2 shows the state where the light-emitting units 4a, 4b and 4c are accommodated in the housing space 5 of the display pixel 4 and the state where the light-emitting units 4a, 4b and 4c are not accommodated in the housing space 5 of the display pixel 4.

As shown in FIG. 2, the display panel 3 has housing spaces 5 for accommodating the display pixel 4 arranged in a matrix. The matrix means here that the housing spaces 5 are arranged in the widthwise direction and lengthwise direction. It should be noted that the arrangement manner of the housing spaces 5 can be selected variously according to the use and object. The arrangement manner of the housing spaces 5 includes, for example, a staggered manner or other arrangement manners. One display pixel 4 is composed of plural light-emitting units, i.e., three light-emitting units 4a, 4b and 4c in this embodiment. The reason why three light-emitting units 4a, 4b and 4c are used is that three colors of RGB are assumed. The light-emitting units 4a, 4b and 4c are only those for at least two colors. The kind of the light-emitting color of the light-emitting units 4a, 4b and 4c can suitably be determined.

Each light-emitting unit 4a, 4b and 4c is accommodated in the housing space 5 so as to be adjacent to one another. It is not essential that the light-emitting units 4a, 4b and 4c are adjacently arranged in the housing space 5. They may be somewhat separated from one another in the housing space 5. The top face of the display panel 3 is preferably painted with black or the like. It does not matter that the top face of the display panel 3 is painted with a color other than black. The top face of the display panel 3 may not be colored. The top face of the display panel 3 can be colored or not colored considering the sight or sense of a viewer. The size of each housing space 5 is, for example, 12 cm in length, 12 cm in breadth and 2 cm in depth, and the size of each light-emitting unit 4a, 4b and 4c is 12 cm in length, 4 cm in breadth and 2 cm in height. These sizes can be determined according to the size of an outdoor-installed large-sized liquid crystal television set, the number of display pixels or the like. The light-emitting units 4a, 4b and 4c are respectively R (red) light-emitting unit 4a, G (green) light-emitting unit 4b and B (blue) light-emitting unit 4c.

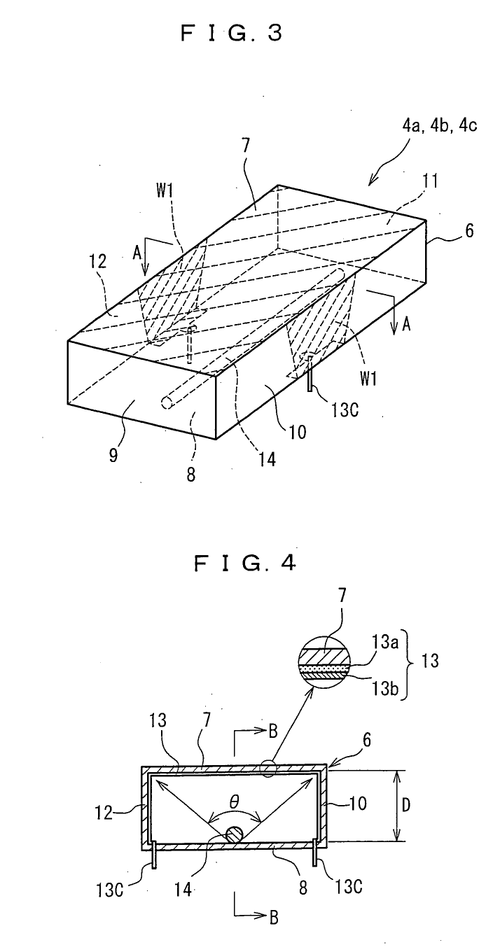

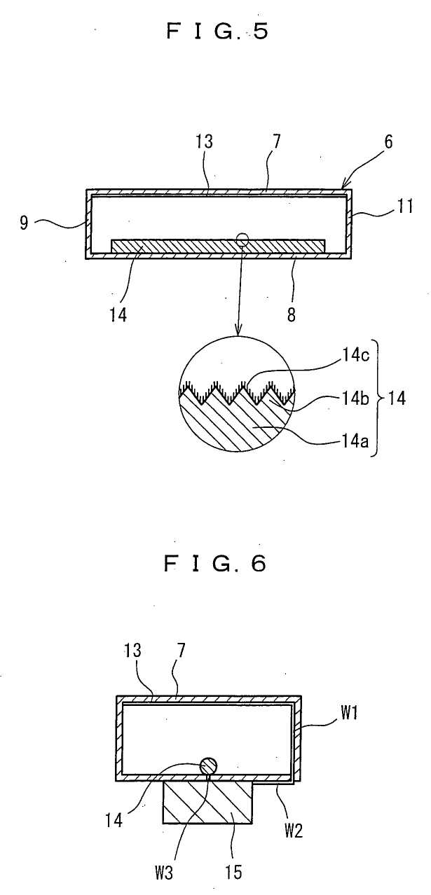

The construction of each of the light-emitting units 4a, 4b and 4c is explained with reference to FIGS. 3 to 5. FIG. 3 is a perspective view of each of the light-emitting units 4a, 4b and 4c, FIG. 4 is a sectional view taken along a line A-A in FIG. 3 and FIG. 5 is a sectional view taken along a line B-B in FIG. 4. The light-emitting units 4a, 4b and 4c are different from one another in the kind of the phosphor, i.e., the phosphor for a light-emission of R color, the phosphor for a light-emission of G color and the phosphor for a light-emission of B color. The other constructions of the light-emitting units 4a, 4b and 4c are the same. Each of the light-emitting units 4a, 4b and 4c has a vacuum sealing tube 6 having a rectangular parallel-epiped of 12 cm in length, 4 cm in breadth and 2 cm in height. A known vacuum technique is used for vacuumizing the inside of the vacuum sealing tube 6, so that its detailed explanation is omitted in the present specification. A seal-off section or the like upon the vacuum is not shown in the figure, and the appearance of the vacuum sealing tube 6 is shown as a rectangle for better understanding.

The vacuum sealing tube 6 is encircled by a top and bottom flat panels 7 and 8, and four side panels 9, 10, 11 and 12. A phosphor-coated anode section 13 is provided at the inner face of one flat panel 7 and a linear cathode section 14 is provided at the inner face of the other flat panel 8 in the vacuum sealing tube 6.

The phosphor-coated anode section 13 has at least a bipolar structure of a phosphor layer 13a uniformly applied onto the inner face of the flat panel 7 and an anode layer 13b made of aluminum deposited onto the phosphor layer 13a. The phosphor layer 13a is excited-by the electron collision to emit light of R color, G color and B color. Each phosphor for R, G and B uses known one used for a CRT (Cathode ray tube). It should be noted that W1 denotes an inner wiring for drawing out an electrode that is provided at the inner faces of the side panel sections 10 and 12 and is electrically connected to the anode layer 13b of the phosphor-coated anode section 13. Numeral 13c denotes a terminal that is connected to the inner wiring W1 and protruded from the outer bottom edge of the light-emitting units 4a, 4b and 4c for drawing the anode layer 13b of the phosphor-coated anode section 13 to the outside.

The linear cathode section 14 is arranged so as to oppose to the phosphor-coated anode section 13 with a predetermined gap D. As shown in Fig.4, the opposing gap D between the phosphor-coated anode section 13 and the linear cathode section 14 is preferably set to a distance such that the electrons radially emitted from the linear cathode section 14 at an emission angle θ can collide with the whole or generally whole phosphor-coated anode section 13. The linear cathode section 14 further has a conductive wire 14a made of nickel or the like, a great number of field concentration assisting concave/convex sections 14b formed at the outer peripheral surface of the conductive wire 14a and a carbon-based film 14c provided with a great number of sharp microscopic sections formed on the concave/convex sections as a field electron emitter. The concave/convex sections 14b include those each having a visible size made by a screw cutting and each having a microscopic size formed by stretching the conductive wire. In the present embodiment, the concave/convex direction of the concave/convex sections 14b is such that they are spirally formed on the outer peripheral surface of the conductive wire 14a, but the concave/convex direction may be the circumferential direction or longitudinal direction of the conductive wire 14a. In this case, it is preferable that the concave/convex direction is aligned from the viewpoint of stabilizing electron emission property. The size, shape or number of the concave/convex sections 14b is not particularly limited. The carbon-based film 14c may be made of carbon nano-tube or carbon nano-wall, but the other carbon-based film 14c can naturally be used. Any conductive wire having conductivity can be used, so that the conductive wire is not limited to nickel.

The method for forming the carbon-based film 14c on the surface of the concave/convex sections 14b of the linear cathode section 14 is not particularly limited. The carbon-based film 14c can be formed by a simple known technique with low cost such as, for example, screen printing, coating, CVD (chemical vapor deposition) or electrodeposition. The carbon nano-tube has, for example, a tube shape with an outer diameter of 1 to several 10 nm and a length of 1 to several nm. An electric field is easy to be concentrated on its leading end due to this tube shape, so that it has a characteristic of easily emitting electrons.

In the light-emitting units 4a, 4b and 4c having the above-mentioned construction, when DC voltage is applied between the phosphor-coated anode section 13 and the linear cathode section 14, an electric field is easily concentrated due to the field concentration assisting concave/convex sections 14b. Further, the sharp sections of the carbon-based film 14c that is the field electron emitter is formed on the concave/convex sections 14b, whereby electric field is more strongly concentrated on the field electron emitter than the case where the field electron emitter is formed on a flat surface, and electrons penetrate through energy barrier due to a quantum tunnel effect to thereby be emitted into vacuum. The emitted electrons are attracted by the phosphor-coated anode section 13 to collide with the phosphor layer 14a, by which the phosphor is excited to emit R color, G color and B color. It should be noted that, since the field concentration is strong, the light-emitting units emit a great number of electrons to thereby emit light with high intensity without a need for providing a gate electrode section for drawing electrons. From this viewpoint, the light-emitting units greatly contribute to simplify a structure, reduce a size, miniaturize, and reduce power consumption.

Although the light-emitting color is defined as three colors of RGB in the above-mentioned embodiment, it can be set according to an object. For example, light-emitting units of two colors among these three colors may be installed, or the light-emitting unit of the other color may be combined.

The display panel 3 having the above-mentioned construction can display a character, diagram or the like with three colors of RGB.

It should be noted that the following construction may be applied as shown in FIG. 6. Specifically, provided at the inner face of the side panel section of the light-emitting units 4a, 4b and 4c are an inner wiring W1 for drawing an electrode and an outer wiring W2 that are electrically connected to the anode layer 13b of the phosphor-coated anode section 13 and a wiring W3 for drawing an electrode that is electrically connected to the conductive wire 14a of the linear cathode section 14. These wirings W2 and W3 are respectively connected to a source terminal of a high-voltage transformer 15 fixed to the backside of the vacuum sealing tube 6, whereby DC high voltage can be applied between the phosphor-coated anode section 13 and the linear cathode section 14 via the wirings.

What is claimed is:

1. A display panel provided with plural display pixels arranged therein comprising:
housing spaces formed so as to individually correspond to the display pixels, and
plural light-emitting units juxtaposed in each of the housing spaces, wherein
each light-emitting unit has a vacuum sealing tube and a phosphor-coated anode section and linear cathode section, each of which is arranged so as to oppose to each other in the vacuum sealing tube,
the linear cathode section has a conductive wire arranged immediately below the phosphor-coated anode section so as to extend linearly, a great number of field concentration assisting concave/convex sections formed on the outer peripheral surface of the conductive wire and a carbon-based film formed as a field electron emitter and having a great number of sharp microscopic sections on the field concentration assisting concave/convex sections, and
each display pixel emits light to be displayed by the plural light-emitting units arranged in each of the housing spaces.

2. A display panel of claim 1, wherein each of the housing spaces is formed to have a concave section.

3. A light-emitting unit used for the display panel claimed in claim 1 or 2.

4. A light-emitting unit of claim 3, comprising a high-voltage transformer for applying DC voltage between the phosphor-coated anode section and linear cathode section.

5. An image display device provided with a data line driving circuit to which information (data) of each color of RGB relating to an image is inputted and that selectively drives plural data lines according to the given information, a scanning line driving circuit that successively selects a scanning line with respect to plural scanning lines in response to a timing control signal and a display panel having display pixels at each intersection where plural data lines from the data line driving circuit and plural scanning lines from the scanning line driving circuit are crosses in a matrix, wherein the display pixels are selectively driven by the data line driving circuit and the scanning line driving circuit to emit light of R (red) color, G (green) color and B (blue) color, wherein
the display panel comprises housing spaces formed so as to individually correspond to the display pixels, and plural light-emitting units juxtaposed in each of the housing spaces,
each light-emitting unit has a vacuum sealing tube and a phosphor-coated anode section and linear cathode section, each of which is arranged so as to oppose to each other in the vacuum sealing tube,
the linear cathode section has a conductive wire arranged immediately below the phosphor-coated anode section so as to extend linearly, a great number of field concentration assisting concave/convex sections formed on the outer peripheral surface of the conductive wire and a carbon-based film formed as a field electron emitter and having a great number of sharp microscopic sections on the field concentration assisting concave/convex sections, and
each display pixel emits light to be displayed by the plural light-emitting units arranged in each of the housing spaces.
